(19) United States
(12) Patent Application Publication
(10) Pub. No.: US 2019/0103917 A1
(43) Pub. Date: Apr. 4, 2019

(54) Optical Pumping Technique

(71) Applicant: Nokia of America Corporation, Murray Hill, NJ (US)

(72) Inventors: Alan H. Gnauck, Middletown, NJ (US); Robert M. Jopson, Rumson, NJ (US); Peter J. Winzer, Aberdeen, NJ (US)

(73) Assignee: Nokia of America Corporation, Murray Hill, NJ (US)

(21) Appl. No.: 16/082,636

(22) PCT Filed: Mar. 7, 2017
(86) PCT No.: PCT/US2017/021132

§ 371 Date: Sep. 6, 2018

Related U.S. Application Data
(60) Provisional application No. 62/306,212, filed on Mar. 10, 2016.

(51) Int. Cl. H04B 10/2537; H01S 3/30; H04J 14/02; H01S 3/094; H01S 3/108

(52) U.S. Cl. CPC H04B 10/2537; H01S 3/302; H01S 3/1086; H01S 3/094046; H04J 14/02

(57) ABSTRACT

A Raman amplifier having an optical pump configured to generate pump bands, each of which is spectrally aligned with a respective wavelength channel of a frequency grid in a manner that enables the pump bands to coexist in an optical fiber with data-carrying signals of other wavelength channels of the frequency grid without causing unworkable levels of inter-channel interference. In an example embodiment, the optical pump comprises a laser whose single-mode output is modulated to sufficiently suppresses stimulated Brillouin scattering in the optical fiber while still keeping the optical power of each of the resulting pump bands spectrally compact, e.g., substantially contained within the slot width of the respective wavelength channel. In some embodiments, at least some pump bands can be spectrally interleaved with some of the data-carrying signals to increase the data-throughput capacity of the corresponding optical transport system.

### CROSS-REFERENCE TO RELATED APPLICATIONS

This application claims priority from U.S. Provisional Patent Application No. 62/306,212 filed on 10 Mar. 2016, and entitled “OPTICAL PUMPING TECHNIQUE,” which is incorporated herein by reference in its entirety.

### BACKGROUND

### Field

The present disclosure relates to optical communication equipment and, more specifically but not exclusively, to optical amplification of communication signals.

### Description of the Related Art

This section introduces aspects that may help facilitate a better understanding of the disclosure. Accordingly, the statements of this section are to be read in this light and are not to be understood as admissions about what is in the prior art or what is not in the prior art.

An optical amplifier is a device that amplifies an optical signal directly in the optical domain without converting the optical signal into a corresponding electrical signal. Optical amplifiers are widely used, for example, in the fields of optical communications and laser physics.

One type of an optical amplifier is a Raman amplifier, which relies on stimulated Raman scattering (SRS) for signal amplification. More specifically, when a signal to be amplified and a pump beam are applied to an optical fiber made of an appropriate material, a lower-frequency signal photon induces SRS of a higher-frequency pump photon, which causes the pump photon to pass some of its energy to the vibrational states of the fiber material, thereby converting the pump photon into an additional signal photon. The pump beam may be coupled into the fiber in the same direction as the signal (co-directional pumping) or in the opposite direction (contra-directional pumping).

### SUMMARY OF SOME SPECIFIC EMBODIMENTS

Disclosed herein are various embodiments of a Raman amplifier having an optical pump configured to generate pump bands, each of which is spectrally aligned with a respective wavelength channel of a frequency grid in a manner that enables the pump bands to coexist in an optical fiber with data-carrying signals of other wavelength channels of the frequency grid without causing unworkable levels of inter-channel interference. In an example embodiment, the optical pump comprises a laser whose single-mode output is modulated to sufficiently suppresses stimulated Brillouin scattering in the optical fiber while still keeping the optical power of each of the resulting pump bands spectrally compact, e.g., substantially contained within the slot width of the respective wavelength channel. In some embodiments, at least some pump bands can be spectrally interleaved with some of the data-carrying signals to increase the data-throughput capacity of the corresponding optical transport system.

According to one embodiment, provided is an apparatus comprising: an optical port to be connected to an optical fiber configured to transmit light of a first set of wavelength channels of a frequency grid; and an optical pump configured to: generate an optical pump signal having one or more pump bands, each of the one or more pump bands being spectrally aligned with a respective wavelength channel of a second set of wavelength channels of the frequency grid; and transmit the optical pump signal, by way of the optical port, through the optical fiber to cause optical amplification of light of at least some of the first set of optical channels due to Raman scattering of the optical pump signal.

According to another embodiment, provided is an optical pumping method comprising the steps of: generating an optical pump signal having one or more pump bands, each of the one or more pump bands being spectrally aligned with a respective wavelength channel of a first set of wavelength channels of a frequency grid; and transmitting the optical pump signal through an optical fiber configured to transmit light of a second set of wavelength channels of the frequency grid in a manner that causes the optical pump signal to induce optical amplification of light of at least some of the second set of optical channels due to Raman scattering of the optical pump signal.

### BRIEF DESCRIPTION OF THE DRAWINGS

Other aspects, features, and benefits of various disclosed embodiments will become more fully apparent, by way of example, from the following detailed description and the accompanying drawings, in which:

FIG. 1 shows a block diagram of an optical transport system according to an embodiment;

FIGS. 2A-2D graphically show example spectra of optical signals that can be used in the optical transport system of FIG. 1 according to an embodiment;

FIG. 3 shows a block diagram of an optical pump source that can be used in the optical transport system of FIG. 1 according to an embodiment;

FIG. 4 shows a block diagram of an optical pump coupler that can be used in the optical transport system of FIG. 1 according to an embodiment;

FIG. 5 shows a block diagram of an optical pump coupler that can be used in the optical transport system of FIG. 1 according to an alternative embodiment; and

FIG. 6 shows a block diagram of an optical pump coupler that can be used in the optical transport system of FIG. 1 according to yet another embodiment.

### DETAILED DESCRIPTION

The most common frequency grid that is used in fiber-optic communication systems is defined by the ITU-T G.694.1 Recommendation, which is incorporated herein by reference in its entirety. This frequency grid can be used, e.g., in the frequency range from about 186 THz to about 201 THz, with a 100, 50, 25, or 12.5-GHz spacing of the channels therein. While defined in frequency units, this grid can equivalently be expressed in wavelength units. For example, in the wavelength range from about 1528.8 nm to about 1563.9 nm, the 100-GHz spacing between the centers of neighboring wavelength channels is equivalent to approximately 0.8 nm spacing. Other frequency grids are also used in fiber-optic communication systems, albeit less frequently.

The following terms are used herein to refer to certain characteristics of a frequency grid.

Frequency grid: A reference set of frequencies used to denote nominal central frequencies that may be used for defining specifications and applications.

Frequency slot: The frequency range allocated to a slot and unavailable to other slots within a frequency grid. A frequency slot is defined by its nominal central frequency and its slot width. A frequency slot may also be referred to as a wavelength channel.

Slot width: The full width of a frequency slot in a frequency grid.

Channel spacing: The frequency difference between the nominal central frequencies of the pertinent frequency slots (wavelength channels).

For illustration purposes and without any implied limitations, various embodiments are described herein in reference to an ITU frequency grid having a 50-GHz slot width.

However, embodiments are not limited to this particular grid or slot width. From the provided description, a person of ordinary skill in the art will be able to practice various embodiments while using other suitable frequency grids and/or slot widths.

For example, some embodiments may be designed to be compatible with a flexible frequency grid, in which some allocated frequency slots may have different respective widths. The latter characteristic can be described, e.g., using the concept of a minimal-width slot. In the corresponding embodiments, some data signals and/or some pump bands may occupy multiple minimal-width slots.

The wavelengths used for optical communications are conventionally divided into several spectral bands in which optical fibers have relatively low transmission losses. For example, the spectral range between 1260 nm and 1625 nm is divided into five telecom bands that are typically referred to as O-, E-, S-, C-, and L-bands. The O-band is in the wavelength range between 1260 nm and 1360 nm. The E-band is in the wavelength range between 1360 nm and 1460 nm. The S-band is in the wavelength range between 1460 nm and 1530 nm. The C-band is in the wavelength range between 1530 nm and 1565 nm. The L-band is in the wavelength range between 1565 nm and 1625 nm.

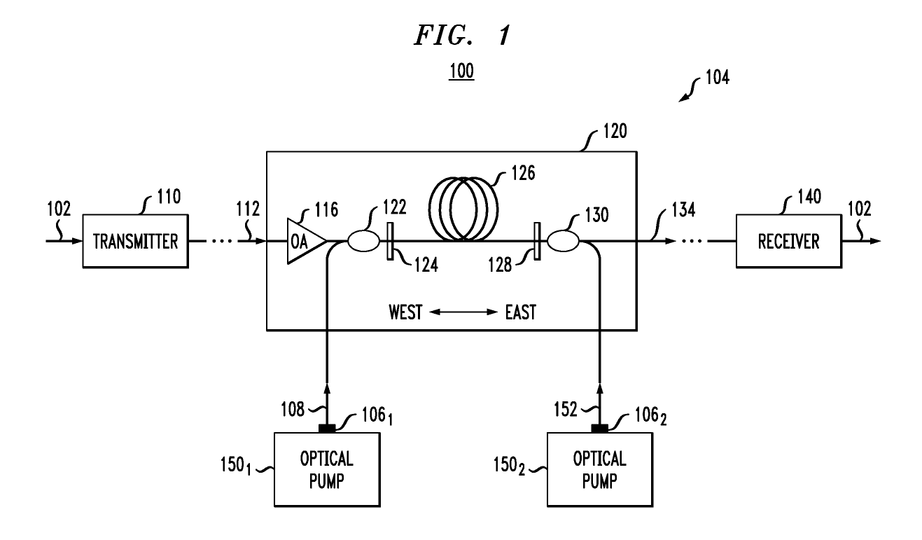

FIG. 1 shows a block diagram of an optical transport system 100 according to an embodiment. System 100 has an optical transmitter 110 and an optical receiver 140 connected by an optical transport link 104. Optical transport link 104 comprises a link section 120 configured to amplify optical communication signals transmitted through that section, e.g., as further described below. In some embodiments, optical transport link 104 may further comprise various additional components (not explicitly shown in FIG. 1), such as optical routing elements, variable optical attenuators, optical amplifiers, optical add-drop multiplexers, optical filters, additional link sections 120, etc.

In an example embodiment, optical transmitter 110 is configured to receive an input data stream 102 and generate a corresponding optical wavelength-division-multiplexed (WDM) signal that is then applied to optical transport link 104 to carry the data of the input data stream to optical receiver 140. Optical receiver 140 is configured to receive the transmitted optical WDM signal from optical transport link 104 and process that signal to recover data stream 102, e.g., for further transmission to external devices.

Section 120 comprises a length of optical fiber 126 that is suitable for Raman amplification of optical WDM signals therein. More specifically, when pumped by pump light through an optical pump coupler 122 and/or an optical pump coupler 130, optical fiber 126 operates as a distributed Raman amplifier that amplifies at least some WDM components.

For illustration purposes and without any implied limitations as to the geographic orientation of section 120, the optical signals propagating therethrough are hereafter referred to as traveling in the eastward direction or in the westward direction. For example, an optical signal generated by optical transmitter 110 and transmitted to optical receiver 140 traverses optical fiber 126 in the eastward direction.

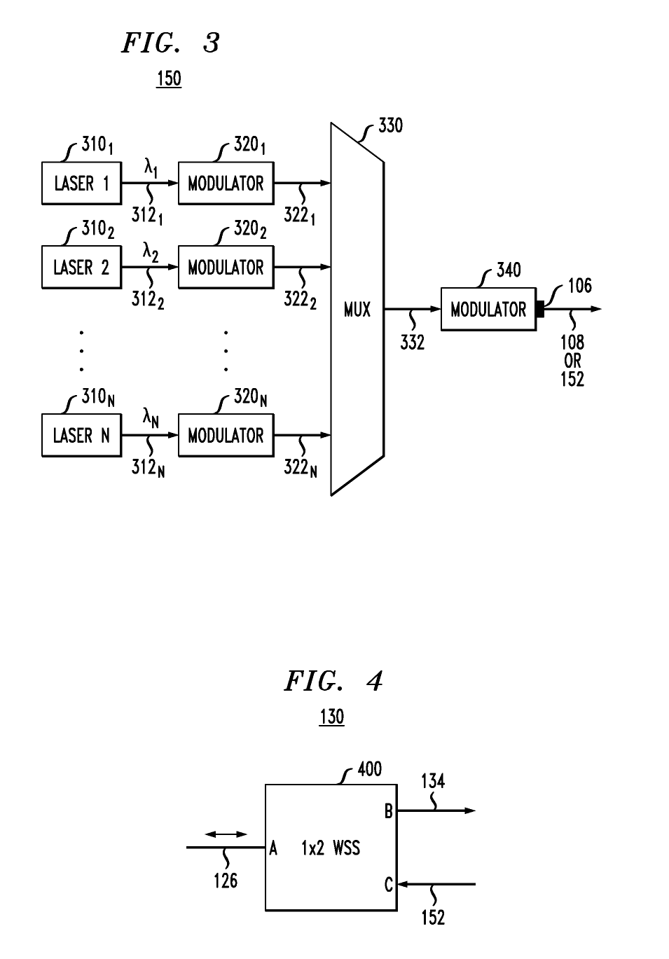

Optical pump coupler 122 is designed and configured for co-directional pumping of optical fiber 126. As such, optical pump coupler 122 causes an optical pump signal 108 generated by an optical pump source 150₁ and applied to the optical pump coupler by way of an optical port 1061 to travel through optical fiber 126 in the eastward direction. Example embodiments of optical pump coupler 122 are described in more detail below in reference to FIG. 6. Example embodiments of optical pump source 150 are described in more detail below in reference to FIG. 3.

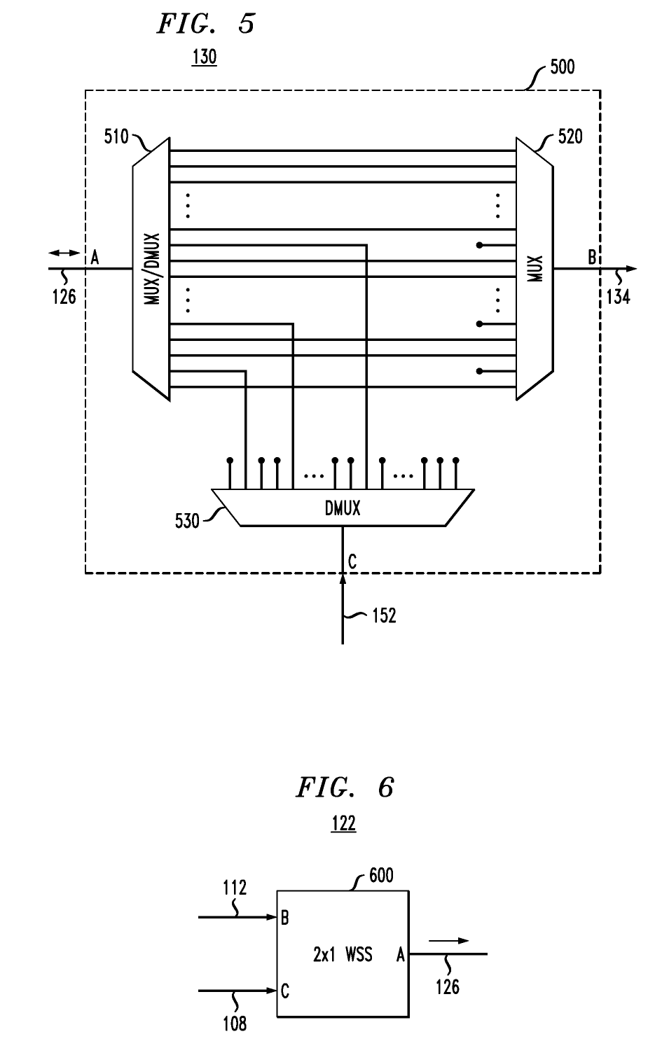

Optical pump coupler 130 is designed and configured for contra-directional pumping of optical fiber 126. As such, optical pump coupler 130 causes an optical pump signal 152 generated by an optical pump source 150₂ and applied to the optical pump coupler by way of an optical port 1062 to travel through optical fiber 126 in the westward direction. Example embodiments of optical pump coupler 130 are described in more detail below in reference to FIGS. 4-5. Optical pump source 150₂ can be similar to optical pump source 150₁. In some embodiments, optical pump sources 150₁ and 150₂ can be configured to generate different respective sets of pump wavelengths.

In some embodiments, section 120 may also comprise an optional additional optical amplifier (OA) 116 and optional optical filters 124 and 128. For example, OA 116 can be used to amplify optical signals that populate a different spectral range or band than the optical signals amplified by the above-mentioned Raman amplification in optical fiber 126. Optical filter 124 may have spectral characteristics that (i) allow the optical communication signals to pass through the filter with little or no attenuation and (ii) cause significant attenuation or blockage of the residual power of the westward-propagating optical pump signal 152, e.g., to protect OA 116 from damage or overload. Optical filter 128 may have spectral characteristics that (i) allow the optical communication signals to pass through the filter with little or no attenuation and (ii) cause significant attenuation or blockage of the residual power of the eastward-propagating optical pump signal 108, e.g., to protect sensitive downstream components (if any) of optical transport link 104 from damage or overload.

In some embodiments, section 120 may have only one of optical couplers 122 and 130. If section 120 only has optical coupler 122, then optical fiber 126 is pumped co-directionally by optical pump signal 108, without receiving optical pump signal 152. If section 120 only has optical couplers 130, then optical fiber 126 is pumped contra-directionally by optical pump signal 152, without receiving optical pump signal 108.

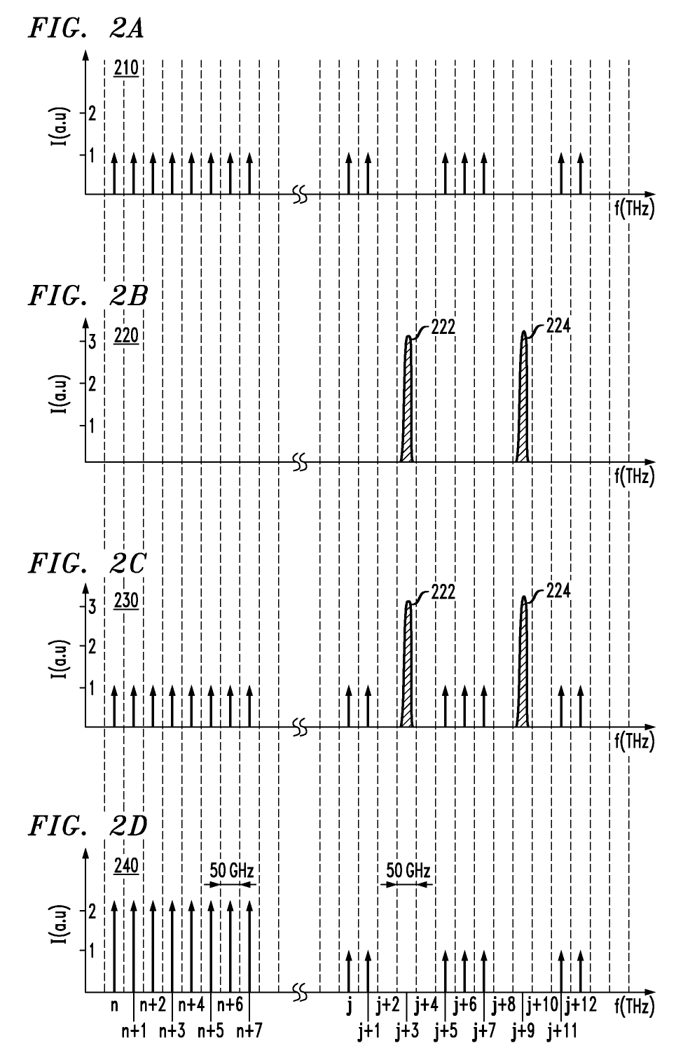

FIGS. 2A-2D graphically show example spectra of optical signals corresponding to section 120 of optical transport link 104 (FIG. 1) according to an embodiment. More specifically, the spectra shown in FIGS. 2A-2D correspond to a contra-directional pumping configuration of section 120. FIG. 2A shows an example spectrum 210 of an optical input signal 112 applied to section 120. FIG. 2B shows an example spectrum 220 of optical pump signal 152 applied by optical pump source 150 to section 120. FIG. 2C shows an example spectrum 230 of light propagating through optical fiber 126. FIG. 2D shows an example spectrum 240 of an optical output signal 134 directed by section 120 toward optical receiver 140. A person of ordinary skill in the art will understand that spectra 210-240 shown in FIGS. 2A-2D are approximate spectra that are presented herein solely to illustrate and/or explain certain technical features of optical transport system 100, and that some embodiments may be configured to use optical signals whose spectra differ from the shown spectra. Furthermore, a co-directional pumping configuration may cause section 120 to carry optical signals that are qualitatively similar to the spectra shown in FIGS. 2A-2D, with some differences being in the propagation direction of the pump light.

The abscissa, which has the same scale in all of FIGS. 2A-2D, indicates the optical frequency (f). The shown frequency range is divided into 50-GHz frequency slots in accordance with the employed frequency grid. The frequency slots are consecutively numbered as indicated in FIG. 2D. The ordinate in each of FIGS. 2A-2D indicates light intensity (I). Each of the data-carrying signals (WDM components) is schematically shown in FIGS. 2A, 2C, and 2D as an arrow, with the length of the arrow indicating the relative signal intensity. A person of ordinary skill in the art will understand that each of the data carrying signals typically has a carrier center band and modulation sidebands, which are not explicitly shown in FIGS. 2A, 2C, and 2D. Each of the spectral components of optical pump signal 152 is schematically shown in FIGS. 2B and 2C as a relatively narrow light band located within the corresponding frequency slot, with the area of the band indicating the optical power of that band. A person of ordinary skill in the art will understand that the actual spectral shape of each pump band depends on the type of modulation used in the process of generating optical pump signal 152, e.g., as explained in reference to FIG. 3. In some alternative embodiments, some data-carrying signals and/or pump bands may occupy more than one slot on the respective frequency grid.

Referring to FIG. 2A, optical input signal 112 is shown as having fifteen WDM components, each having a relatively low intensity, e.g., due to optical losses in one or more sections of optical transport link 104 located between optical transmitter 110 and link section 120 (also see FIG. 1). In the shown example, the WDM components populate the following frequency slots (wavelength channels) of the employed frequency grid: (i) from n-th to (n+7)-th; (ii) j-th; (iii) (j+1)-th; (iv) from (j+5)-th to (j+7)-th; (v) (j+11)-th; and (vi) (j+12)-th, where j>(n+7). In an example embodiment, the n-th to (n+7)-th frequency slots can be located in the L-band, while the j-th to (j+12)-th frequency slots can be located in the S-band.

Referring to FIG. 2B, optical pump signal 152 is shown as having two relatively intense pump bands, which are labeled 222 and 224, respectively. In an example embodiment, the center frequencies of pump bands 222 and 224 can be aligned with the nominal central frequencies of the (j+3)-th and (j+9)-th frequency slots, respectively, of the employed frequency grid. Each of pump bands 222 and 224 has a relatively narrow spectral width, which causes most (e.g., >50% or >90%) of the band's optical power to be contained within the corresponding one 50-GHz frequency slot. For example, most of the optical power of pump band 222 is contained within the (j+3)-th frequency slot. Most of the optical power of pump band 224 is similarly contained within the (j+9)-th frequency slot. Also note that optical input signal 112 does not have any WDM components in the (j+3)-th and (j+9)-th frequency slots, which is clear from comparison of spectrum 210 (FIG. 2A) and spectrum 220 (FIG. 2B).

A person of ordinary skill in the art will understand that, in an alternative embodiment, optical pump signal 152 can have a different (from two) number of optical pump bands analogous to pump bands 222 and 224. Embodiments in which optical pump signal 152 has a single optical pump band analogous to one of pump bands 222 and 224 are also contemplated. In some embodiments, at least some of the pump bands generated by optical pump signal 152 may occupy more than one frequency slot, but fewer than, e.g., ten frequency slots.

Referring to FIG. 2C, spectrum 230 of the light propagating through optical fiber 126 is substantially a superposition of spectra 210 (FIG. 2A) and 220 (FIG. 2B), which causes pump bands 222 and 224 of optical pump signal 152 to be spectrally interleaved with some of the data-carrying WDM components of optical input signal 112. The light corresponding to the WDM components of optical input signal 112 is propagating through optical fiber 126 in the eastward direction. The light corresponding to bands 222 and 224 of optical pump signal 152 is propagating through optical fiber 126 in the westward direction. In this manner, optical fiber 126 is configured to operate as a contra-directionally pumped Raman amplifier.

A noteworthy feature of spectrum 230 is that the frequency slots that are directly adjacent to pump bands 222 and 224 are vacant and do not contain any WDM components therein. For example, the vacant (j+2)-th and (j+4)-th frequency slots surround pump band 222. The vacant (j+8)-th and (j+10)-th frequency slots similarly surround pump band 224. Due to the presence of these vacant frequency slots, the channel spacing between a data channel and a pump channel in spectrum 230 is at least 100 GHz.

In an alternative embodiment, optical input signal 112 and optical pump signal 152 can be generated in a manner that causes the channel spacing between a data channel and a pump channel in spectrum 230 to be at least 150 GHz or more.

In some embodiments, optical input signal 112 and optical pump signal 152 can be generated in a manner that causes no vacant frequency slots to be present between some pump and data channels.

In general, it may be beneficial to reduce the number of vacant frequency slots (idle wavelength channels). For example, in some embodiments, the number of vacant frequency slots between a pump channel and a nearest active data channel in a spectrum analogous to spectrum 230 may not exceed, e.g., ten, eight, six, four, or two, which corresponds to the channel spacing of 500 GHz, 400 GHz, 300 GHz, 200 GHz, or 100 GHz, respectively.

Referring to FIG. 2D, optical output signal 134 has the same WDM components as optical input signal 112 (FIG. 2A). However, signals 112 and 134 differ in that each of the n-th through (n+7)-th WDM components of optical output signal 134 has a higher intensity than the corresponding WDM component of optical input signal 112, which is evident from comparison of spectra 240 (FIG. 2D) and 210 (FIG. 2A). This increase in the intensity is due to Raman amplification of these WDM components in optical fiber 126 caused by energy transfer from pump bands 222 and 224.

In the shown example, the j-th, (j+1)-th, (j+5)-th, (j+6)-th, (j+7)-th, (j+11)-th, and (j+12)-th WDM components of optical input signal 112 (FIG. 2A) are not amplified in section 120, which is evident from further comparison of spectra 240 (FIG. 2D) and 210 (FIG. 2A). However, in an alternative configuration, the latter WDM components can be amplified, e.g., using OA 116 or an additional (differently configured) Raman amplifier placed between link section 120 and optical receiver 140.

In general, due to certain fundamental properties and limitations of SRS in an optical fiber, a pump band spectrally located in a selected telecom band can typically be used to pump data-carrying WDM components spectrally located in another telecom band. For example, if the j-th, (j+1)-th, (j+5)-th, (j+6)-th, (j+7)-th, (j+11)-th, and (j+12)-th WDM-signal components of optical input signal 112 are spectrally located in the S-band, then these WDM-signal components can be amplified in a Raman amplifier configured to use one or more pump bands located, e.g., in the E-band, etc.

FIG. 3 shows a block diagram of optical pump source 150 according to an embodiment. Optical port 106 and optical pump signal 108/152 are also shown in FIG. 3 to better illustrate the relationship between the circuits of FIGS. 1 and 3. Optical pump source 150 of FIG. 3 can be used to implement either of optical pump sources 150₁ and 150₂ (FIG. 1).

Optical pump source 150 comprises lasers 310₁-310_{N} configured to generate a plurality of pump beams 312₁-312_{N} having wavelengths λ₁-λ_{N}, respectively, where N is a positive integer greater than one. In an example embodiment, each of pump beams 312₁-312_{N} is substantially monochromatic and has a spectral line width that is on the order of or smaller than 0.1 GHz. This property of pump beams 312₁-312_{N} can be achieved, e.g., by employing (i) single-mode continuous-wave lasers 310₁-310_{N} or (ii) multi-mode lasers 310₁-310_{N} whose output is appropriately filtered to pass through only the modes that are spectrally located within the desired spectral width. In addition, wavelengths λ₁-λ_{N} are selected such that each of these wavelengths is aligned with the central frequency of the corresponding frequency slot of the frequency grid. For example, the pump-beam configuration illustrated in FIG. 2C corresponds to N=2. In this particular configuration, wavelengths λ₁ and λ₂ are aligned with the central frequencies of the (j+3)-th and (j+9)-th frequency slots, respectively.

Optical pump source 150 further comprises optical modulators 320₁-320_{N}, each configured to modulate a respective one of pump beams 312₁-312_{N}. The resulting modulated pump beams 322₁-322_{N} are applied to a multiplexer (MUX) 330, wherein the modulated pump beams are multiplexed to generate a multiplexed pump beam 332. Multiplexed pump beam 332 can be further modulated in an optical modulator 340 to generate optical pump signal 152.

In some alternative embodiments, some of the shown optical modulators may be omitted from the shown structure of optical pump source 150. For example, in one alternative embodiment, some or all of optical modulators 320₁-320_{N} can be omitted. In another alternative embodiment, optical modulator 340 can be omitted.

In some embodiments, optical pump source 150 can employ lasers 310₁-310_{N} that are capable of generating modulated pump beams 312₁-312_{N}, e.g., using intra-cavity modulation, injection-current modulation, and/or bias-voltage modulation. In such embodiments, some or all of optical modulators 320₁-320_{N} and 340 can be omitted.

In an example embodiment, lasers 310₁-310_{N} and optical modulators 320₁-320_{N} and 340 are configured to generate optical pump signal 152 in a manner that causes the generated optical pump signal to cause a relatively low level of stimulated Brillouin scattering (SBS) in optical fiber 126. A person of ordinary skill in the art will understand that a relatively low level of SBS in optical fiber 126 can be beneficial, e.g., because it enables optical output signal 134 to be detected and decoded with a relatively low bit-error rate (BER) due to a reduced level of inter-channel crosstalk.

In various embodiments, lasers 310₁-310_{N} and/or optical modulators 320₁-320_{N} and 340 can be configured to apply (i) frequency modulation, (ii) phase modulation, (iii) amplitude modulation, (iv) polarization-mode modulation, or (v) some combination of some or all of (i)-(iv). For example, in one embodiment, good suppression of SBS can be achieved using a multi-tone phase modulation, wherein the set of modulation tones includes the following example radio frequencies: 70 MHz; 250 MHz; 800 MHz; and 2.5 GHz. In an alternative embodiment, sufficiently good suppression of SBS can be achieved, e.g., using various types of modulation that employ one or more modulation frequencies selected from the range between ca. 1 GHz and ca. 50 GHz.

In general, the above-described modulation can be configured to spectrally broaden the spectral lines generated by lasers 310₁-310_{N} to an extent that is sufficient to satisfactorily suppress the SBS in optical fiber 126. At the same time, the modulation can be such that the resulting spectral broadening of the spectral lines does not cause significant inter-channel crosstalk, e.g., due to the modulation sidebands of the pump signals interfering with the data signals that populate adjacent frequency slots. In some embodiments, the modulation type and/or format can be selected and optimized to achieve an acceptable trade-off between the SBS suppression and the BER penalty caused by inter-channel crosstalk between data and pump channels.

In some embodiments, lasers 310₁-310_{N} can be tunable.

In some embodiments, MUX 330 can be designed and configured to perform polarization multiplexing in addition to or instead of wavelength multiplexing.

FIG. 4 shows a block diagram of optical pump coupler 130 according to an embodiment. Optical fiber 126, optical output signal 134, and optical pump signal 152 are also shown in FIG. 4 to better illustrate the relationship between the circuits of FIGS. 1 and 4. In the shown embodiment, optical pump coupler 130 comprises a 1×2 wavelength-selective switch (WSS) 400, whose three ports are labeled A, B, and C. Port A is connected to optical fiber 126 and is configured to operate as a bidirectional (input/output) port. Port B is configured to output optical signal 134 and operates as a unidirectional output port. Port C is configured to receive optical pump signal 152 and operates as a unidirectional input port. It should be specifically noted that the optical signals (i.e., 134 and 152) handled by ports B and C travel in opposite directions.

As known in the pertinent art, a 1×M WSS is a (re)configurable optical multiplexer/de-multiplexer having (M+1) optical ports that are divided into first and second subsets in terms of their respective functions, where M is a positive integer greater than one. The first subset has a single optical port, which may also be referred to as the common port.

The second subset has the other M ports, which may be referred to as plural ports. In operation, a 1×M WSS can be configured to route the full set or any selected subset of K wavelength (frequency) channels between its common port and any selected one of its plural ports. A common port typically has the following features. When an input port, a common port can be configured to variously distribute light of the received channels among the plural ports such that different plural ports internally receive and externally output different non-overlapping subsets of the K wavelength channels. One of these possible configurations can be such that all wavelength channels externally applied to the common port go to a single plural port while other plural ports receive no wavelength channels from the common port. When an output port, a common port can internally collect and externally output up to K wavelength channels from the different plural ports such that different plural ports contribute different non-overlapping subsets of the K wavelength channels. Again, one of these possible configurations can be such that all wavelength channels internally collected by the common port originate from a single plural port while other plural ports contribute no wavelength channels to the common port. It is customary to depict a 1×M WSS using a block diagram in which (i) the common port is shown at the WSS side having a single port and (ii) a plural port is any of the ports located at the WSS side having multiple ports. For example, for WSS 400 shown in FIG. 4, port A is the common port, and ports B and C are plural ports.

As used herein, the term “bidirectional” refers to a port configuration in which a WSS port can transmit optical signals traveling in both directions, at the same time. For example, light of a first set of wavelength channels that passes through a bidirectional port may travel in a first (e.g., eastward) direction, whereas light of a second set of wavelength channels that passes through that port may travel in the opposite second (e.g., westward) direction at the same time. As such, in at least some time instances, a bidirectional port operates to transmit light in both directions, thereby operating as an input port and an output port at the same time. In a typical configuration, the first and second sets of wavelength channels may have no channels in common. A bidirectional WSS port differs from a unidirectional WSS port in that, at any time instance, a unidirectional port operates to transmit light in a single (e.g., eastward or westward) direction.

In an example embodiment, the wavelength channels of WSS 400 are spectrally aligned with the frequency slots of the employed frequency grid. Using this characteristic, WSS 400 can be configured to implement the embodiment illustrated in FIGS. 2A-2D, for example, as follows:

(I) wavelength channels routed between ports A and B correspond to the following frequency slots of the employed frequency grid: (i) from n-th to (n+7)-th; (ii) j-th; (iii) (j+1)-th; (iv) from (j+5)-th to (j+7)-th; (v) (j+11)-th; and (vi) (j+12)-th; and (II) wavelength channels routed between ports A and C correspond to the (j+3)-th and (j+9)-th frequency slots of the employed frequency grid.

In this configuration, port A operates as a bidirectional port that is (i) an input port for the wavelength channels routed between ports A and B, and (ii) an output port for the wavelength channels routed between ports A and C. Port B operates as an output port for the wavelength channels routed between ports A and B. Port C operates as an input port for the wavelength channels routed between ports A and C.

From the above description and examples, a person of ordinary skill in the art will understand, without undue experimentation, how to design and configure WSS 400 for any practical frequency-slot allocation that can be used in optical transport system 100 (FIG. 1). Suitable hardware that can be used to implement WSS 400 is disclosed, e.g., in U.S. Pat. No. 9,225,458, which is incorporated herein by reference in its entirety.

A person of ordinary skill in the art will appreciate that the embodiment of optical pump coupler 130 shown in FIG. 4 advantageously enables various wavelength channels to be flexibly reassigned from being data channels to being pump channels, and vice versa, if appropriate or necessary.

FIG. 5 shows a block diagram of optical pump coupler 130 according to an alternative embodiment. Optical fiber 126, optical output signal 134, and optical pump signal 152 are also shown in FIG. 5 to better illustrate the relationship between the circuits of FIGS. 1 and 5.

In the shown embodiment, optical pump coupler 130 comprises an optical device 500 whose three optical ports are labeled A, B, and C. In an example embodiment, external functions of ports A, B, and C of optical device 500 are analogous to the above-described external functions of ports A, B, and C, respectively, of WSS 400 (FIG. 4). More specifically, port A of optical device 500 is connected to optical fiber 126 and is configured to operate as a bidirectional (input/output) port. Port B of optical device 500 is configured to output optical output signal 134 and operates as a unidirectional output port. Port C of optical device 500 is configured to receive optical pump signal 152 and operates as a unidirectional input port.

Optical device 500 comprises wavelength multiplexers 510, 520, and 530 interconnected as indicated in FIG. 5. Wavelength multiplexers 510, 520, and 530 are also connected to ports A, B, and C of optical device 500 as further indicated in FIG. 5. In the shown embodiment, wavelength multiplexers 510, 520, and 530 can be nominal copies of one another and have an equal number of ports. For illustration purposes and without any implied limitations, the subsequent description of optical device 500 is given in reference to this particular embodiment. A person of ordinary skill in the art will understand that, in an alternative embodiment, wavelength multiplexers 510, 520, and 530 may not be nominal copies of one another and may have different respective numbers of ports.

In the shown embodiment, transmission characteristics of each of wavelength multiplexers 510, 520, and 530 can be represented by nominally the same set of pass bands that are spectrally aligned with the frequency slots of the employed frequency grid. The interconnections between the single-channel ports of wavelength multiplexers 510, 520, and 530 are such that: (i) wavelength channels populated by optical pump signal 152 are routed from wavelength multiplexer 530 to wavelength multiplexer 510; and (ii) wavelength channels populated by the WDM components of optical input signal 112 are routed from wavelength multiplexer 510 to wavelength multiplexer 520.

As a result, wavelength multiplexer 520 is configured to operate as a multiplexer. Wavelength multiplexer 530 is configured to operate as a de-multiplexer. The configuration of wavelength multiplexer 510 differs from the configurations of either of wavelength multiplexers 520 and 530 in that wavelength multiplexer 510 is configured to operate both as a multiplexer and as a de-multiplexer at the same time. More specifically, for the wavelength channels populated by optical pump signal 152, wavelength multiplexer 510 operates as a multiplexer, whereas for the wavelength channels populated by the WDM components of optical input signal 112, wavelength multiplexer 510 operates as a de-multiplexer.

Some of the single-channel ports of wavelength multiplexers 510, 520, and 530 may remain unconnected and/or blocked, e.g., as indicated by the small filled circles in FIG. 5.

For example, to implement the embodiment illustrated in FIGS. 2A-2D, the single-channel ports of wavelength multiplexers 510, 520, and 530 can be connected using the following procedure.

First, the single-channel ports of each of wavelength multiplexers 510, 520, and 530 are sorted into first, second, and third sets of ports. The first set includes the optical ports corresponding to the wavelength channels aligned with the following frequency slots of the employed frequency grid: (i) from n-th to (n+7)-th; (ii) j-th; (iii) (j+1)-th; (iv) from (j+5)-th to (j+7)-th; (v) (j+11)-th; and (vi) (j+12)-th. The second set includes the optical ports corresponding to the wavelength channels aligned with the (j+3)-th and (j+9)-th frequency slots of the employed frequency grid. The third set includes the optical ports corresponding to the unpopulated wavelength channels.

Second, the following single-channel port interconnections are made:
(I) each port of the first set of wavelength multiplexer 510 is connected to the corresponding port of the first set of wavelength multiplexer 520; and
(II) each port of the second set of wavelength multiplexer 510 is connected to the corresponding port of the second set of wavelength multiplexer 530.

Third, the following single-channel ports are blocked: (i) ports of the first set of wavelength multiplexer 530; and (ii) ports of the second set of wavelength multiplexer 520. Optionally, ports of the third set of each of wavelength multiplexers 510, 520, and 530 can also be blocked.

A person of ordinary skill in the art will appreciate that the embodiment of optical pump coupler 130 shown in FIG. 5 provides fixed interconnections between single-channel ports of wavelength multiplexers 510, 520, and 530. As such, this embodiment is suitable for use in systems in which various wavelength channels are fixedly assigned to be data channels or pump channels.

In some embodiments, wavelength multiplexers 530 (FIG. 5) and 330 (FIG. 3) can be removed, and pump beams 322₁-322_{N} can be applied directly to appropriate single-channel ports of wavelength multiplexer 510.

FIG. 6 shows a block diagram of optical pump coupler 122 according to an embodiment. Optical fiber 126, optical input signal 112, and optical pump signal 108 are also shown in FIG. 6 to better illustrate the relationship between the circuits of FIGS. 1 and 6.

In the shown embodiment, optical pump coupler 122 comprises a 2×1 WSS 600, whose three ports are labeled A, B, and C. Port A is connected to optical fiber 126 and is configured to operate as a unidirectional output port. Port B is configured to receive optical signal 112 and operates as a unidirectional input port. Port C is configured to receive optical pump signal 108 and operates as a unidirectional input port.

In some embodiments, WSS 600 can be a nominal copy of WSS 400, with a main configuration difference being in the propagation direction of some optical signals handled by the two WSSs.

According to an example embodiment disclosed above in reference to FIGS. 1-6, provided is an apparatus (e.g., 100, FIG. 1) comprising: an optical fiber (e.g., 126, FIG. 1) configured to transmit light (e.g., 112/134, FIG. 1) of a first set of wavelength channels of a frequency grid; and an optical pump (e.g., 150, FIGS. 1 and 3) configured to: generate an optical pump signal (e.g., 108/152, FIGS. 1 and 3) having one or more pump bands (e.g., 222/224, FIG. 2B), each of the one or more pump bands being spectrally aligned with a respective wavelength channel of a second set of wavelength channels of the frequency grid; and transmit the optical pump signal through the optical fiber; and wherein the optical fiber is further configured to cause optical amplification of light of at least some (e.g. n-th to (n+7)-th, FIG. 2D) of the first set of optical channels due to Raman scattering of the optical pump signal therein.

According to another example embodiment disclosed above in reference to FIGS. 1-6, provided is an apparatus (e.g., 100, FIG. 1) comprising: an optical port (e.g., 106, FIGS. 1 and 3) to be connected to an optical fiber (e.g., 126, FIG. 1) configured to transmit light (e.g., 112/134, FIG. 1) of a first set of wavelength channels of a frequency grid; and an optical pump (e.g., 150, FIGS. 1 and 3) configured to: generate an optical pump signal (e.g., 108/152, FIGS. 1 and 3) having one or more pump bands (e.g., 222/224, FIG. 2B), each of the one or more pump bands being spectrally aligned with a respective wavelength channel of a second set of wavelength channels of the frequency grid; and transmit the optical pump signal, by way of the optical port, through the optical fiber to cause optical amplification of light of at least some (e.g. n-th to (n+7)-th, FIG. 2D) of the first set of optical channels due to Raman scattering of the optical pump signal.

In some embodiments of the above apparatus, the optical fiber is configured to transmit the light of the first set of wavelength channels in a first (e.g., eastward, FIG. 1) direction; and wherein the optical pump is configured to transmit the optical pump signal through the optical fiber in a second (e.g., westward, FIG. 1) direction opposite to the first direction.

In some embodiments of any of the above apparatus, the first and second sets of wavelength channels have no wavelength channels in common (e.g., as indicated in FIGS. 2A-2D).

In some embodiments of any of the above apparatus, at least some wavelength channels of the second set are interleaved with wavelength channels of the first set.

In some embodiments of any of the above apparatus, a channel spacing between at least one wavelength channel of the first set and at least one wavelength channel of the second set is smaller than 500 GHz (e.g., as indicated in FIG. 2C).

In some embodiments of any of the above apparatus, the channel spacing is greater than 50 GHz (e.g., as indicated in FIG. 2C).

In some embodiments of any of the above apparatus, the first and second sets of wavelength channels are compatible with an ITU-T G.694.1 Recommendation.

In some embodiments of any of the above apparatus, the optical pump is configured to generate the optical pump signal in a manner that causes at least 50% of optical power of a pump band to be spectrally contained within the respective wavelength channel.

In some embodiments of any of the above apparatus, the apparatus further comprises an optical coupler (e.g., 130, FIGS. 1, 4, 5) disposed between the optical port and an end of the optical fiber and configured to: optically couple light of the first set of wavelength channels through the end and out of the optical fiber; and optically couple the optical pump signal through the end and into the optical fiber.

In some embodiments of any of the above apparatus, the optical coupler comprises a wavelength-selective switch (e.g., 400, FIG. 4).

In some embodiments of any of the above apparatus, the optical coupler comprises two or more interconnected wavelength multiplexers (e.g., 510, 520, 530, FIG. 5).

In some embodiments of any of the above apparatus, the optical coupler comprises first, second, and third coupler ports (e.g., A, B, C, FIGS. 4, 5); the first coupler port is connected to the end of the optical fiber and configured to operate as a bidirectional port; the second coupler port is connected to receive the optical pump signal from the optical pump and configured to operate as a unidirectional input port; and the third coupler port is connected to another optical fiber (e.g., downstream section of 104, FIG. 1) and configured to operate as a unidirectional output port.

In some embodiments of any of the above apparatus, the optical pump comprises: a laser source (e.g., 310₁-310_{N}, FIG. 3); and an optical modulator (e.g., 320 and/or 340, FIG. 3) configured to modulate light generated by the laser source to generate the one or more pump bands.

In some embodiments of any of the above apparatus, the optical modulator is configured to modulate the light generated by the laser source using one or more of the following: frequency modulation; phase modulation; amplitude modulation; and polarization-mode modulation.

In some embodiments of any of the above apparatus, the laser source comprises: a first laser (e.g., 310₁, FIG. 3) configured to generate a first pump band having a first polarization; and a second laser (e.g., 310₂, FIG. 3) configured to generate a second pump band having a different second polarization.

In some embodiments of any of the above apparatus, the optical pump comprises a multiplexer (e.g., 330, FIG. 3) configured to multiplex the first pump band and the second pump band to generate the optical pump signal.

In some embodiments of any of the above apparatus, the first pump band and the second pump band have a common wavelength.

In some embodiments of any of the above apparatus, the optical pump comprises a laser source (e.g., 310, FIG. 3) configured to use intra-cavity modulation, injection-current modulation, or bias-voltage modulation to generate the one or more pump bands.

In some embodiments of any of the above apparatus, the apparatus further comprises an optical transmitter (e.g., 110, FIG. 1) configured to: populate the first set of optical channels by data-carrying signals; and transmit the data-carrying signals through the optical fiber.

In some embodiments of any of the above apparatus, the apparatus further comprises an optical receiver (e.g., 140, FIG. 1) optically connected to the optical transmitter by way of an optical link (e.g., 104, FIG. 1) and configured to receive therethrough at least some of the data-carrying signals, wherein the optical link includes the optical fiber.

In some embodiments of any of the above apparatus, the one or more pump bands are spectrally located in a first telecom band (e.g., one of the O-, E-, S-, C-, and L-bands); and the at least some of the first set of optical channels are spectrally located in a different second telecom band (e.g., another one of the O-, E-, S-, C-, and L-bands).

In some embodiments of any of the above apparatus, the one or more pump bands include two pump bands (e.g., 222 and 224, FIG. 2B).

In some embodiments of any of the above apparatus, the first set of wavelength channels includes at least one wavelength channel (e.g., (j+5)-th to (j+7)-th, FIG. 2C) spectrally located between the two pump bands.

According to yet another example embodiment disclosed above in reference to FIGS. 1-6, provided is an optical pumping method comprising the steps of: transmitting light (e.g., 112/134, FIG. 1) through an optical fiber (e.g., 126, FIG. 1), the light populating a first set of wavelength channels of a frequency grid; generating an optical pump signal (e.g., 152, FIGS. 1 and 3) having one or more pump bands (e.g., 222/224, FIG. 2B), each of the one or more pump bands being spectrally aligned with a respective wavelength channel of a second set of wavelength channels of the frequency grid; and transmitting the optical pump signal through the optical fiber to cause optical amplification of light of at least some (e.g. n-th to (n+7)-th, FIG. 2D) of the first set of optical channels due to Raman scattering of the optical pump signal in the optical fiber.

While this disclosure includes references to illustrative embodiments, this specification is not intended to be construed in a limiting sense. Various modifications of the described embodiments, as well as other embodiments within the scope of the disclosure, which are apparent to persons skilled in the art to which the disclosure pertains are deemed to lie within the principle and scope of the disclosure, e.g., as expressed in the following claims.

Unless explicitly stated otherwise, each numerical value and range should be interpreted as being approximate as if the word “about” or “approximately” preceded the value or range.

It will be further understood that various changes in the details, materials, and arrangements of the parts which have been described and illustrated in order to explain the nature of this disclosure may be made by those skilled in the art without departing from the scope of the disclosure, e.g., as expressed in the following claims.

Although the elements in the following method claims, if any, are recited in a particular sequence with corresponding labeling, unless the claim recitations otherwise imply a particular sequence for implementing some or all of those elements, those elements are not necessarily intended to be limited to being implemented in that particular sequence.

Reference herein to “one embodiment” or “an embodiment” means that a particular feature, structure, or characteristic described in connection with the embodiment can be included in at least one embodiment of the disclosure. The appearances of the phrase “in one embodiment” in various places in the specification are not necessarily all referring to the same embodiment, nor are separate or alternative embodiments necessarily mutually exclusive of other embodiments. The same applies to the term “implementation.”

Also for purposes of this description, the terms “couple,” “coupling,” “coupled,” “connect,” “connecting,” or “connected” refer to any manner known in the art or later developed in which energy is allowed to be transferred between two or more elements, and the interposition of one or more additional elements is contemplated, although not required. Conversely, the terms “directly coupled,” “directly connected,” etc., imply the absence of such additional elements.

The described embodiments are to be considered in all respects as only illustrative and not restrictive. In particular, the scope of the disclosure is indicated by the appended claims rather than by the description and figures herein. All changes that come within the meaning and range of equivalency of the claims are to be embraced within their scope.

The description and drawings merely illustrate the principles of the disclosure. It will thus be appreciated that those of ordinary skill in the art will be able to devise various arrangements that, although not explicitly described or shown herein, embody the principles of the disclosure and are included within its spirit and scope. Furthermore, all examples recited herein are principally intended expressly to be only for pedagogical purposes to aid the reader in understanding the principles of the disclosure and the concepts contributed by the inventor(s) to furthering the art, and are to be construed as being without limitation to such specifically recited examples and conditions. Moreover, all statements herein reciting principles, aspects, and embodiments of the disclosure, as well as specific examples thereof, are intended to encompass equivalents thereof.

As used herein in reference to an ITU standard or recommendation, the term “compatible” means that the corresponding element or feature is implemented in a manner wholly or partially specified by the standard, and is enabled by the corresponding hardware as sufficiently compliant with the standard or recommendation. The corresponding hardware does not need to operate internally in a manner specified by the standard.

What is claimed is:

1. An apparatus comprising:
an optical port to be connected to an optical fiber configured to transmit light of a first set of wavelength channels of a frequency grid; and
an optical pump configured to:
generate an optical pump signal having one or more pump bands, each of the one or more pump bands being spectrally aligned with a respective wavelength channel of a second set of wavelength channels of the frequency grid; and
transmit the optical pump signal, by way of the optical port, through the optical fiber to cause optical amplification of light of at least some of the first set of optical channels due to Raman scattering of the optical pump signal.

2. The apparatus of claim 1,
wherein the optical fiber is configured to transmit the light of the first set of wavelength channels in a first direction; and
wherein the optical pump is configured to transmit the optical pump signal through the optical fiber in a second direction opposite to the first direction.

3. The apparatus of claim 1, wherein the first and second sets of wavelength channels have no wavelength channels in common.

4. The apparatus of claim 1, wherein at least some wavelength channels of the second set are interleaved with wavelength channels of the first set.

5. The apparatus of claim 1, wherein a channel spacing between at least one wavelength channel of the first set and at least one wavelength channel of the second set is smaller than 500 GHz.

6. The apparatus of claim 1, wherein the first and second sets of wavelength channels are compatible with an ITU-T G.694.1 Recommendation.

7. The apparatus of claim 1, wherein the optical pump is configured to generate the optical pump signal in a manner that causes at least 50% of optical power of a pump band to be spectrally contained within the respective wavelength channel.

8. The apparatus of claim 1, further comprising an optical coupler configured to be disposed between the optical port and an end of the optical fiber and configured to:
optically couple light of the first set of wavelength channels through the end and out of the optical fiber; and
optically couple the optical pump signal through the end and into the optical fiber.

9. The apparatus of claim 8, wherein the optical coupler comprises a wavelength-selective switch.

10. The apparatus of claim 8, wherein the optical coupler comprises two or more interconnected wavelength multiplexers.

11. The apparatus of claim 8, wherein:
the optical coupler comprises first, second, and third coupler ports;
the first coupler port is connectable to the end of the optical fiber and configured to operate as a bidirectional port;
the second coupler port is connectable to receive the optical pump signal from the optical pump and configured to operate as a unidirectional input port; and
the third coupler port is connectable to another optical fiber and configured to operate as a unidirectional output port.

12. The apparatus of claim 1, wherein the optical pump comprises:
a laser source; and
an optical modulator configured to modulate light generated by the laser source to generate the one or more pump bands.

13. The apparatus of claim 12, wherein the optical modulator is configured to modulate the light generated by the laser source using one or more of the following:
frequency modulation;
phase modulation;
amplitude modulation; and
polarization-mode modulation.

14. The apparatus of claim 12,
wherein the laser source comprises:
a first laser configured to generate a first pump band having a first polarization; and
a second laser configured to generate a second pump band having a different second polarization; and
wherein the optical pump comprises a multiplexer configured to multiplex the first pump band and the second pump band to generate the optical pump signal.

15. The apparatus of claim 1, wherein the optical pump comprises a laser source configured to use intra-cavity modulation, injection-current modulation, or bias-voltage modulation to generate the one or more pump bands.

16. The apparatus of claim 1, further comprising an optical transmitter configured to:
populate the first set of optical channels by data-carrying signals; and
transmit the data-carrying signals through the optical fiber.

17. The apparatus of claim 16, further comprising an optical receiver optically connected to the optical transmitter by way of an optical link and configured to receive therethrough at least some of the data-carrying signals, wherein the optical link includes the optical fiber.

18. The apparatus of claim 1, wherein:
the one or more pump bands are spectrally located in a first telecom band; and
the at least some of the first set of optical channels are spectrally located in a different second telecom band.

19. The apparatus of claim 1,
wherein the one or more pump bands include two pump bands; and
wherein the first set of wavelength channels includes at least one wavelength channel spectrally located between the two pump bands.

20. An optical pumping method comprising:
generating an optical pump signal having one or more pump bands, each of the one or more pump bands being spectrally aligned with a respective wavelength channel of a first set of wavelength channels of a frequency grid; and
transmitting the optical pump signal through an optical fiber configured to transmit light of a second set of wavelength channels of the frequency grid in a manner that causes the optical pump signal to induce optical amplification of light of at least some of the second set of optical channels due to Raman scattering of the optical pump signal.
